(19) United States
(12) Patent Application Publication
(10) Pub. No.: US 2011/0124806 A1
(43) Pub. Date: May 26, 2011

(54) DIMENSIONALLY STABLE POLYIMIDES, AND METHODS RELATING THERETO

(75) Inventors: John W. Simmons, Wilmington, DE (US); Brian C. Auman, Pickerington, OH (US); Kostantinos Kourtakis, Media, PA (US); Salah Boussaad, Wilmington, DE (US)

(73) Assignee: E.I. DU PONT DE NEMOURS AND COMPANY, Wilmington, DE (US)

(21) Appl. No.: 12/622,977

(22) Filed: Nov. 20, 2009

(51) Int. Cl. C08L 79/08; C08G 73/10

(52) U.S. Cl. 524/600; 528/353

(57) ABSTRACT

A film is disclosed, containing 40-100 weight percent polyimide. The polyimide is derived from a dianhydride component and a diamine component. The dianhydride component is at least 3,3′,4,4′-biphenyl tetracarboxylic dianhydride (BPDA), and optionally is also pyromellitic dianhydride (PMDA) in a mole ratio of 50-100:50-0 (BPDA:PMDA). The diamine component comprises 1,5-naphthalenediamine (1,5-ND) and 1,4-diaminobenzene (PPD) and/or meta phenylene diamine (MPD) in a mole ratio of 15-95:85-5 (1,5-ND:PPD+MPD). The films have exceptional high temperature storage modulus (elastic modulus) and exceptionally low high temperature creep (eₚₗₐₛₜ).

### FIELD OF DISCLOSURE

The present disclosure relates generally to thermally and dimensionally stable polyimides useful in high temperature applications. More specifically, the polyimides of the present disclosure are derived from: a) a dianhydride component comprising 3,3′,4,4′-biphenyl tetracarboxylic dianhydride (BPDA), and optionally, pyromellitic dianhydride (PMDA); and b) a diamine component comprising: i. 1,5-naphthalenediamine (1,5-ND); and ii. 1,4-diaminobenzene (PPD) and/or meta phenylene diamine (MPD).

### BACKGROUND OF THE DISCLOSURE

Broadly speaking, polyimide substrates in electronics applications are known. In the electronics industry, there is a need for lower cost polyimide substrates having improved dimensional and thermal stability properties.

Japanese patent number JP61-25 8835 to Oota et al. (Mitsubishi Chemical Industries) discloses a copolyimide obtained by reacting pyromellitic anhydride (PMDA) with naphthalenediamine and diaminodiphenyl ether.

### SUMMARY

The present disclosure is directed to a film containing a polyimide in an amount between and optionally including any two of the following weight percentages: 40, 50, 60, 65, 70, 75, 80, 85, 90, 95, and 100 weight percent of the film. The polyimide is derived from a dianhydride component and a diamine component. The dianhydride component is at least 3,3′,4,4′-biphenyl tetracarboxylic dianhydride (BPDA), and optionally is also pyromellitic dianhydride (PMDA) in a mole ratio of 50-100:50-0 (BPDA:PMDA). The diamine component comprises 1,5-naphthalenediamine (1,5-ND) and 1,4-diaminobenzene (PPD) and/or meta phenylene diamine (MPD) in a mole ratio of 15-95:85-5 (1,5-ND:PPD+MPD). The compositions of the present invention have exceptional high temperature storage modulus (elastic modulus) and exceptionally low high temperature creep (eₚₗₐₛₜ).

### DETAILED DESCRIPTION OF THE PREFERRED EMBODIMENTS

The term “film” herein denotes a free standing film or a coating on a substrate. The term “film” is used interchangeably with the term “layer” and refers to covering a desired area.

“Dianhydride” as used herein is intended to also include precursors and derivatives of (or otherwise compositions related to) dianhydrides, which may not technically be dianhydrides but are nevertheless functionally equivalent due to the capability of reacting with a diamine to form a polyamic acid which in turn could be converted into a polyimide.

Similarly, “diamine” is intended to also include precursors and derivatives of (or otherwise compositions related to) diamines, which may not technically be diamines but are nevertheless functionally equivalent due to the capability of reacting with a dianhydride to form a polyamic acid which in turn could be converted into a polyimide.

Polymers described herein are generally referred to according to the monomers used in their creation. Hence a polyimide described as a BPDA/1,5-ND polyimide is intended to mean a polyimide derived from the polymerization reaction product of BPDA and 1,5-ND.

The in-plane or linear coefficient of thermal expansion (CTE) of the polyimide film of the present disclosure can be obtained by thermomechanical analysis utilizing a TA Instruments TMA-2940 run at 10° C./min, up to 380° C., then cooled and reheated to 380° C., with the CTE in ppm/° C. obtained during the reheat scan between 50° C. and 350° C.

As used herein, the terms “comprises,” “comprising,” “includes,” “including,” “has,” “having” or any other variation thereof, are intended to cover a non-exclusive inclusion. For example, a method, process, article, or apparatus that comprises a list of elements is not necessarily limited only those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Useful polyimides of the present disclosure are derived from a diamine component and a dianhydride component. At least 80, 85, 90, 92, 94, 95, 96, 97, 98, 99 or 100 mole percent of the diamine component comprises: i. 1,5-naphthalenediamine (1,5-ND); and ii. at least one member of the group consisting of 1,4-diaminobenzene (PPD) and meta phenylene diamine (MPD) in a mole ratio of 15-95:85-5 (1,5-ND:PPD and/or MPD). MPD is sometimes referred to as 1,3-diaminobenzene. The dianhydride component comprises 3,3′,4,4′-biphenyl tetracarboxylic dianhydride (BPDA), and optionally, pyromellitic dianhydride (PMDA) in a mole ratio of 50-100:50-0 (BPDA:PMDA).

In one embodiment, the mole ratio of BPDA:PMDA is A:B where A is any range between and optionally including any two of the following: 50, 55, 60, 65, 70, 75, 80, 85, 90, 95 and 100, and B is any range between and optionally including any two of the following: 50, 45, 40, 35, 30, 25, 20, 15, 10, 5 and 0. In one embodiment the ratio of 1,5ND:PPD and/or MPD is C:D where C is any range between and optionally including any two of the following: 15, 20, 25, 30, 35, 40, 45, 50, 55, 60, 65, 70, 75, 80, 85, 90 and 95, and D is any range between and optionally including any two of the following: 85, 80, 75, 70, 65, 60, 55, 50, 45, 40, 35, 30, 25, 20, 15, 10, and 5.

Polyimides of the present disclosure can be made by methods well known in the art. In one embodiment, the polyimide film according to the present disclosure can be produced by combining the above monomers together with a solvent to form a polyamic acid (also called a polyamide acid) solution. The dianhydride and diamine components are typically combined in a molar ratio of aromatic dianhydride component to aromatic diamine component of from 0.90 to 1.10. Molecular weight can be adjusted by adjusting the molar ratio of the dianhydride and diamine components.

In instances where a chemical conversion (in contradistinction to a thermal conversion process can also be appropriate in the practice of the present invention), a polyamic acid casting solution is derived from the polyamic acid solution. In one embodiment, the polyamic acid casting solution comprises the polyamic acid solution combined with conversion chemicals like: (i) one or more dehydrating agents, such as, aliphatic acid anhydrides (acetic anhydride, etc.) and aromatic acid anhydrides; and (ii) one or more catalysts, such as, aliphatic tertiary amines (triethylamine, etc.), aromatic tertiary amines (dimethylaniline, etc) and heterocyclic tertiary amines (pyridine, picoline, isoquinoline, etc). The anhydride dehydrating material is often used in a molar excess of the amount of amide acid groups in the polyamic acid. The amount of acetic anhydride used is typically about 2.0-3.0 moles per equivalent of amic acid groups. Generally, a comparable amount of tertiary amine catalyst is used.

In one embodiment, the polyamic acid solution and/or the polyamic acid casting solution contains an organic solvent at a concentration from about 5, 10 or 12% to about 12, 15, 20, 25, 27, 30 or from about 40, 45, 50, 55, 60, 65, 70, 75, 80, 85, or 90% by weight. Examples of suitable solvents include: sulfoxide solvents (dimethyl sulfoxide, diethyl sulfoxide, etc.), formamide solvents (N,N-dimethylformamide, N,N-diethylformamide, etc.), acetamide solvents (N,N-dimethylacetamide, N,N-diethylacetamide, etc.), pyrrolidone solvents (N-methyl-2-pyrrolidone, N-vinyl-2-pyrrolidone, etc.), phenol solvents (phenol, o-, m- or p-cresol, xylenol, halogenated phenols, catechol, etc.), hexamethylphosphoramide and gamma-butyrolactone. It is desirable to use one of these solvents or mixtures thereof. It is also possible to use combinations of these solvents with aromatic hydrocarbons such as xylene and toluene, or ether containing solvents like diglyme, propylene glycol methyl ether, propylene glycol, methyl ether acetate, tetrahydrofuran, and the like.

The polyamic acid (and casting solution) can further comprise any one of a number of additives, such as processing aids (e.g., oligomers), antioxidants, light stabilizers, flame retardant additives, anti-static agents, heat stabilizers, ultraviolet absorbing agents, fillers or various reinforcing agents.

The solvated mixture (the polyamic acid casting solution) can then be cast or applied onto a support, such as an endless belt or rotating drum, to give a film. Next, the solvent containing-film can be converted into a self-supporting film by baking at an appropriate temperature (thermal curing) together with conversion chemical reactants (chemical curing). The film can then be separated from the support, oriented such as by tentering, with continued thermal and chemical curing to provide a polyimide film.

Useful methods for producing polyimide film in accordance with the present invention can be found in U.S. Pat. No. 5,166,308 to Kreuz, et al. Numerous variations are also possible, such as: (a) a method wherein the diamine components and dianhydride components are preliminarily mixed together and then the mixture is added in portions to a solvent while stirring, (b) a method wherein a solvent is added to a stirring mixture of diamine and dianhydride components (contrary to (a) above), (c) a method wherein diamines are exclusively dissolved in a solvent and then dianhydrides are added thereto at such a ratio as allowing to control the reaction rate, (d) a method wherein the dianhydride components are exclusively dissolved in a solvent and then amine components are added thereto at such a ratio to allow control of the reaction rate, (e) a method wherein the diamine components and the dianhydride components are separately dissolved in solvents and then these solutions are mixed in a reactor, (f) a method wherein the polyamic acid with excessive amine component and another polyamic acid with excessive dianhydride component are preliminarily formed and then reacted with each other in a reactor, particularly in such a way as to create a non-random or block copolymer, (g) a method wherein a specific portion of the amine components and the dianhydride components are first reacted and then the residual diamine components are reacted, or vice versa, (h) a method wherein the conversion chemicals are mixed with the polyamic acid to form a polyamic acid casting solution and then cast to form a gel film, (i) a method wherein the components are added in part or in whole in any order to either part or whole of the solvent, also where part or all of any component can be added as a solution in part or all of the solvent, (j) a method of first reacting one of the dianhydride components with one of the diamine components giving a first polyamic acid, then reacting the other dianhydride component with the other amine component to give a second polyamic acid, and then combining the amic acids in any one of a number of ways prior to film formation.

In some embodiments, the polyimide dielectric layer comprises a filler. The addition of filler increases the storage modulus, particularly above the Tg of the polyimide, producing a more dimensionally stable polyimide capable of handling the high temperatures associated with flexible printed wiring boards, wire (or other electrical) insulation, flexible heaters, protective films, and CIGS processing. In some embodiments, the filler is selected from the group consisting of spherical or near spherical shaped fillers, platelet-shaped fillers, needle-like fillers, fibrous fillers and mixtures thereof. In some embodiments, the platelet-shaped fillers and needle-like fillers and fibrous fillers will maintain or lower the CTE of the polyimide layer while still increasing the storage modulus. In some embodiments, the filler is selected from the group consisting of mica, talc, boron nitride, wollastonite, clays, calcinated clays, silica, alumina, titania, zirconia and mixtures thereof. The fillers may be treated or untreated.

In some embodiments, the filler is selected from a group consisting of oxides (e.g., oxides comprising silicon, titanium, magnesium and/or aluminum), nitrides (e.g., nitrides comprising boron and/or silicon) or carbides (e.g., carbides comprising tungsten and/or silicon). In some embodiments, the filler comprises oxygen and at least one member of the group consisting of aluminum, silicon, titanium, magnesium and combinations thereof. In some embodiments, the filler comprises platelet talc, acicular titanium dioxide, and/or acicular titanium dioxide which at least a portion of which is coated with an aluminum oxide. In some embodiments the filler is less than 50, 25, 20, 15, 12, 10, 8, 6, 5, 4, 2, 1, 0.8, 0.75, 0.65, 0.5, 0.4, 0.3, or 0.25 microns in all dimensions.

In another embodiment, low amounts of carbon fiber and graphite may be used. In yet another embodiment, low amounts of carbon fiber and graphite may be used in combination with other fillers. In some embodiments, the filler is coated with (or the polyamic acid or polyimide otherwise comprises) a coupling agent. In some embodiments, the filler is coated with (or the polyamic acid or polyimide otherwise comprises) an aminosilane coupling agent. In some embodiments, the filler is coated with (or the polyamic acid or polyimide otherwise comprises) a dispersant. In some embodiments, this filler is coated with (or the polyamic acid or polyimide otherwise comprises) a combination of a coupling agent and a dispersant. Depending on the particular filler used, too low a filler loading may have minimal impact on the film properties, while too high a filler loading may cause the polyimide to become brittle. Ordinary skill and experimentation may be necessary in selecting any particular filler in accordance with the present disclosure, depending upon the particular application selected. In some embodiments, the filler is present in an amount between (and optionally including) any two of the following weight percentages: 5, 10, 15, 10, 25, 30, 35, 40, 45, 50, 55, and 60 weight percent of the total weight of the polyimide dielectric layer.

In some embodiments, suitable fillers are generally stable at temperatures above 350° C., and in some embodiments do not significantly decrease the electrical insulation properties of the film. In some embodiments, the filler is selected from a group consisting of needle-like fillers, fibrous fillers, platelet fillers and mixtures thereof. In one embodiment the filler is spherical or near spherical. In one embodiment, the fillers of the present disclosure exhibit an aspect ratio of at least 3, 4, 5, 6, 7, 8, 9, 10, 11, 12, 13, 14, or 15 to 1. In one embodiment, the filler aspect ratio is 6:1. In another embodiment, the filler aspect ratio is 10:1, and in another embodiment, the aspect ratio is 12:1.

In some embodiments, the filler comprises materials derived from nanoparticles of silicon oxide, aluminum oxide, titanium oxide, niobium oxide, tantalum oxide and their mixtures to promote compatibilization with the metal foil substrate. In some embodiments, the average diameter of these nanoparticles can be 200 nm or less and can encompass aspect ratios ranging from one (spherical particles) to higher aspect ratios (oblong spheres, nanoneedles). The nanoparticles can encompass 1-30 wt % of the total weight of the polyimide layer and can be added optionally with dispersant or silane or other type coupling agents and can be combined with other fillers to produce the final polyimide dielectric layer.

In some embodiments, there is a practical limit to the filler particle size. If the filler size is too large, then desired surface smoothness may not be obtained. If the filler is too small, agglomeration may occur and good dispersion may not be achieved, which can result in low dielectric strength. Therefore when selecting the size of filler, the balance between desired surface roughness of the film, filler dispersability and processibility should be considered. In some embodiments, the polyimide layer comprises a nanofiller. The term nanofiller is intended to mean a filler with at least one dimension less than 1000 nm, i.e., less than 1 micron. In some embodiments, special dispersion techniques may be necessary when nanofillers are used as they can be more difficult to disperse. In some embodiments the filler has at least one dimension that (on average) is less than 1000, 800, 600, 500, 450, 400, 350, 300, 275, 250, 225 or 200 nanometers (nm).

In some embodiments, the polyimide layer has an isothermal weight loss of less than 1% at 500° C. over 30 minutes under inert conditions, such as in a substantial vacuum, a nitrogen or any inert gas environment. In some embodiments, the polyimide dielectric layer has a thickness between (and optionally including) any two of the following thicknesses 4, 6, 8, 10, 20, 30, 40, 50, 60, 70, 80, 90 and 100 microns.

In some embodiments, the polyimide dielectric film of the present disclosure has a dielectric strength greater than 10, 20 25, 30, 35, 40, 40, 75, 100, 150 or 200 KV/mm.

In some embodiments, the polyimide film of the present disclosure is as free as possible of pinholes or other defects (foreign particles, conductive particles, gels, filler agglomerates and other contaminates) that could harm electrical performance. The term “pinhole” as used herein includes any small holes that result from non-uniformities in a layer or otherwise arising from the manufacturing process.

The polyimide dielectric layer can be made thicker in an attempt to decrease defects or their impact on the film's integrity or alternatively, multiple polyimide dielectric layers may be used. Thin multiple polyimide layers can be advantageous over a single polyimide layer of the same thickness. Such polyimide multilayers can greatly eliminate the occurrence of through-film pinholes or defects, because the likelihood of defects that overlap in each of the individual layers is extremely small. In some embodiments, the polyimide film of the present disclosure comprises two or more layers of polyimide. In some embodiments, the polyimides layers may be the same. In some embodiments, the polyimide layers may be different.

### Examples

The invention will be further described in the following examples, which do not limit the scope of the invention described in the claims.

### Polyamic Acid Preparation:

A 250 mL 4-necked round-bottom flask, equipped with a mechanical stirrer and a nitrogen inlet, was charged with a diamine (or diamines). The N,N-dimethylacetamide (reactions were generally run at 15-20%) solids, based on weight of polyamic acid) was added with stirring. After the diamine(s) were dissolved, the dianhydride was added and the reaction was stirred at room temperature overnight. Table 1 lists the chemical composition and molar ratios of diamine(s) and dianhydride.

TABLE 1

| Sample | | | Mole %1/ | | Mole % |
|---|---|---|---|---|---|
| # | Diamine 1 | Diamine 2 | Mole %2 | Dianhyride 1 | Dianhydride |
| 1 | 1,5-ND | — | 100/0 | BPDA | 100 |
| 2 | 1,5-ND | PPD | 75/25 | BPDA | 100 |
| 3 | 1,5-ND | PPD | 50/50 | BPDA | 100 |
| 4 | 1,5-ND | PPD | 25/75 | BPDA | 100 |
| 5 | 1,5-ND | PPD | 5/95 | BPDA | 100 |
| Comp | — | PPD | 0/100 | BPDA | 100 |
| Ex 1 | | | | | |
| Comp | 1,5-ND | ODA | 70/30 | PMDA | 100 |
| Ex 2 | | | | | |
| Comp | 1,5-ND | ODA | 20/80 | PMDA | 100 |
| Ex 3 | | | | | |
| Comp | 1,5-ND | ODA | 70/30 | BPDA | 100 |
| Ex 4 | | | | | |
| Comp | 1,5-ND | ODA | 20/80 | BPDA | 100 |
| Ex 5 | | | | | |
| Comp | — | ODA | 100 | PMDA | 100 |
| Ex 6 | | | | | |

### Film Preparation

A dense film of each polymer was cast from the polyamic acid solution (synthesized in the General Procedure above). The polyamic acid solution was cast onto a glass plate at 25° C. with a 15-mil (38×10⁻⁵ m) knife gap. The film was dried on the plate at 100° C. for 1-2 hours, removed from the plate, and dried in a vacuum oven under nitrogen at 50° C. overnight. The film was further dried in a vacuum oven (roughly 20 inches mercury) at 200° C. for 3 days under a nitrogen atmosphere. The film of thickness between 2×10⁻⁵ and 5×10⁻⁵ m (1-2 mils) was thus obtained.

All of the polyimide films were characterized by several analytical methods and these are summarized in Table 2. A Dynamic Mechanical Analysis (DMA) instrument was used to characterize the mechanical behavior of the polyimide films. DMA operation was based on the viscoelastic response of polymers subjected to a small oscillatory strain (e.g., 10 μm) as a function of temperature and time (TA Instruments, New Castle, Del., USA, DMA 2980). The films were operated in tension and multifrequency-strain mode, where a finite size of rectangular specimen was clamped between stationary jaws and movable jaws. Samples of 6-6.4 mm width, 0.03-0.05 mm thickness and 10 mm length in the MD direction were fastened with 3 in-lb torque force. The static force in the length direction was 0.05 N with autotension of 125%. The film was heated at frequency of 1 Hz from 0° C. to 500° C. at 3° C./min rate. The storage modulii at 100 and 500° C. are recorded on Table 2.

Thermal Gravimetric Analysis (TGA) was carried out on a TA Instruments TGA-2050. Samples were heated under nitrogen at 10° C./min from room temperature to 500° C. and then held at 500° C. for 30 minutes. The weight loss from the beginning to the end of the isothermal hold at 500° C. is taken as a percentage of the initial sample weight. The reported data was normalized after a 10 minute ramp in order to remove differences in water content between the samples.

TABLE 2
Modulus and TGA Data

| | | | TGA |
|---|---|---|---|
| | Storage | Storage | (% wt loss |
| | Modulus | Modulus | @ 500° C., |
| Sample # | (100° C.), MPa | (500° C.) | normalized) |
| 1 | 4712 | 1633 | 1.20 |
| 2 | 6054 | 1192 | 1.00 |
| 3 | 6227 | 744 | 1.00 |
| 4 | 5026 | 587 | 0.80 |
| 5 | 7500 | 569 | 0.68 |
| Comp Ex 1 | 6119 | 368 | 0.42 |
| Comp Ex 2 | 4100 | 750 | 2.40 |
| Comp Ex 3 | 3100 | 30 | |
| Comp Ex 4 | 4200 | 196 | 0.98 |
| Comp Ex 5 | 2967 | 21 | 1.04 |
| Comp Ex 6 | 2915 | 98 | 1.30 |

### Measurement of High Temperature Creep

A DMA (TA Instruments Q800 model) was used for a creep/recovery study of film specimens in tension and customized controlled force mode. A pressed film of 6-6.4 mm width, 0.03-0.05 mm thickness and 10 mm length was clamped between stationary jaws and movable jaws in 3 in-lb torque force. The static force in the length direction was 0.005N. The film was heated to 460° C. at 20° C./min rate and held at 460° C. for 150 min. The creep program was set at 2 MPa for 20 min, followed by recovery for 30 min with no additional force other than the initial static force of (0.005N). The creep/recovery program was repeated for 4 MPa and 8 MPa and the same time intervals as that for 2 MPa.

In Table 3 below are tabulated the strain and the recovery following the cycle at 8 MPa. The elongation is converted to a unitless equivalent strain by dividing the elongation by the starting film length. The strain at 8 MPa and 460° C. is tabulated, “emax”. The term “e max” is the dimensionless strain which is corrected for any changes in the film due to decomposition and solvent loss (as extrapolated from the stress free slope) at the end of the 8 MPa cycle. The term “e rec” is the strain recovery immediately following the 8 MPa cycle but at no additional applied force (other than the initial static force of 0.005 N), which is a measure of the recovery of the material, corrected for any changes in film due to decomposition and solvent loss as measured by the stress free slope). The column “e plast”, describes the plastic flow, and is a direct measure of high temperature creep, and is the difference between e max and e rec.

In general, a material which exhibits the lowest possible strain (e max), the lowest amount of stress plastic flow (e plast) and a low value of the stress free slope is desirable.

TABLE 3

| | Applied | | | | | |
|---|---|---|---|---|---|---|
| | Stress | e max (strain | | | | |
| Sample # | (MPA)* | at applied stress) | % Strain | e rec | e plast | % Plast |
| 1 | 8 | 5.24E−03 | 0.52 | 4.17E−03 | 1.07E−03 | 0.11 |
| 2 | 8 | 7.17E−03 | 0.72 | 5.43E−03 | 1.74E−03 | 0.17 |
| 3 | 8 | 1.14E−02 | 1.14 | 8.25E−03 | 3.13E−03 | 0.31 |
| 4 | 8 | 1.19E−02 | 1.19 | 9.26E−03 | 2.60E−03 | 0.26 |
| 5 | 8 | 1.12E−02 | 1.12 | 8.45E−03 | 2.72E−03 | 0.27 |
| Comp Ex 1 | 8 | 1.62E−02 | 1.62 | 1.36E−02 | 2.63E−03 | 0.26 |
| Comp Ex 2 | 8 | 1.31E−02 | 1.31 | 5.68E−03 | 7.40E−03 | 0.74 |
| Comp Ex 3 | 8 | 1.45E−01 | 14.5 | 7.75E−02 | 6.76E−02 | 6.76 |
| Comp Ex 4 | 8 | 3.93E−02 | 3.93 | 1.80E−02 | 1.66E−02 | 1.66 |
| Comp Ex 5 | 8 | Film breaks | | | | |
| Comp Ex 6 | 8 | 8.58E−02 | 8.58 | 3.84E−02 | 4.74E−02 | 4.74 |

Example 1 illustrates that when only 1,5 naphthalene diamine as the diamine, the high temperature storage modulus is good, TGA is acceptable and the e max and e plast are low.

Examples 2-5 illustrate that 1,5 naphthalene diamine can replace 5 to 75 wt % of PPD and provide good high temperature storage modulus, acceptable TGA and low e max and e plast.

Comparative example 1 illustrates that without the addition of 1,5-napthalene diamine the high temperature storage modulus is low and the e max is high.

Comparative examples 2, illustrate that when ODA is used in combination with 1,5-naphthalene diamine the high temperature storage modulus is acceptable the TGA, e max and e plast are high.

Comparative examples 3, illustrates that when ODA is used in combination with 1,5-naphthalene diamine the high temperature storage modulus is low, e max and e plast are high.

Comparative examples 4, illustrates that when a ODA is used in combination with 1,5-naphthalene diamine the high temperature storage modulus is low, e max and e plast are high.

Comparative examples 5, illustrates that when ODA is used in combination with 1,5-naphthalene diamine the high temperature storage modulus is low and the film breaks during e max test.

Comparative examples 6, illustrate that when ODA is used alone the high temperature storage modulus is low, the TGA, e max and e plast are high.

What is claimed is:

1. A film comprising:
A) a polyimide in an amount from 40 to 100 weight percent of the film, the polyimide being derived from a dianhydride component and a diamine component, wherein:
a) the dianydride component is 3,3′,4,4′-biphenyl tetracarboxylic dianhydride (BPDA), and optionally, pyromellitic dianhydride (PMDA) in a mole ratio of 50-100:50-0 (BPDA:PMDA); and
b) the diamine component comprises 1,5-naphthalenediamine (1,5-ND) and at least one member of the group consisting of 1,4-diaminobenzene (PPD) and meta phenylene diamine (MPD) in a mole ratio of 15-95:85-5 (1,5-ND:PPD and MPD).

2. A film according to claim 1, wherein the dianhydride component is BPDA.

3. A film according to claim 1, wherein the mole ratio of BPDA:PMDA is 60-90:40-10.

4. A film according to claim 1, wherein the diamine component comprises only 1,5-ND and PPD.

5. A film according to claim 1, wherein the ratio of 1,5-ND:PPD and MPD is sufficient to provide an absolute value stress free slope of less than 10 times (10)⁻⁶ per minute, and an eₘₐₓ of less than 1% at 7.4-8 MPa.

6. A film according to claim 1, wherein 5 to 40 weight percent of the film comprises a filler, the filler having at least one dimension on average of less than 500 nanometers.

7. A film according to claim 6, further comprising a coupling agent, a dispersant or a combination thereof.
